(19) United States
(12) Patent Application Publication
(10) Pub. No.: US 2003/0146547 A1
(43) Pub. Date: Aug. 7, 2003

(54) Method for recovering mixed plastic matter

(76) Inventors: Eberhard Fischer, Kelkheim (DE); Robert Schleich, Kelkheim (DE); Thomas Kaiser, Kelkheim (DE); Bernd Bungert, Hofheim (DE); Andreas Thiele, Aachen (DE); Guido Gorski, Kurten (DE)

Correspondence Address: Aslan Baghdadi, Shaw Pittmann, 1650 Tysons Boulevard, McLean, VA, 22102, US

(21) Appl. No.: 10/220,690

(22) PCT Filed: Jan. 13, 2001
(86) PCT No.: PCT/DE01/04704

(30) Foreign Application Priority Data
Dec. 15, 2000 (DE) 100-62-437.5

(51) Int. Cl. B29B 17/00

(52) U.S. Cl. 264/340

(57) ABSTRACT

A process for treating mixed plastics waste that comprises macromolecular polymers and low molecular weight polymers is described. The process includes the steps of: introducing the mixed plastics waste into an organic solvent to produce a suspension, the solvent being one in which at least one of the macromolecular polymers is soluble at a specific temperature; maintaining the suspension at a normal pressure and at an operating temperature at which none of the macromolecular polymers dissolve; extracting the low molecular weight polymers from the mixed plastics waste to produce a solution containing dissolved low molecular weight polymers and an extracted mixed plastics waste; and removing the extracted mixed plastics waste. The process can include additional steps, such as dissolving at least one of the macromolecular polymers at a temperature (T1) that is different from the operating temperature and separating the dissolved macromolecular polymer from the remaining polymers before dissolving the low molecular weight polymers.

### BACKGROUND

1. Field of the Invention

The present invention relates to a process for treating mixed plastics waste, in which the waste is composed of macromolecular polymers contaminated with low molecular weight polymers and other contaminants.

2. Background of the Invention

Mixed plastics waste is composed of macromolecular polymers contaminated with low molecular weight polymers and other contaminants. “Macromolecular polymers” include polymers having a molecular weight of more than approximately 10,000, such as polyvinylchloride, polystyrene, polyethylene-terephthalate, polypropylene and polyethylene such as, for example, LDPE (low density polyethylene), LLDPE (linear low density polyethylene), MDPE (medium density polyethylene), HDPE (high density polyethylene), UHDPE (ultra high density polyethylene), each with a corresponding degree of polymerization.

In contrast, “low molecular weight polymers” include polymers having a molecular weight up to approximately 5,000, such as waxes or degraded macromolecular polymers. The other contaminants in the mixed plastics waste can include soluble or insoluble components/pollutants, including but not limited to: polyester, paper, aluminums and other polymers.

Mixed plastics waste is one type of waste from which useful materials can be extracted and reprocessed. Mixed plastic waste is one component of waste generated from used packaging. In Germany, the Duales System was introduced in order to collect, sort and recover used packaging, and to implement government regulations controlling packaging in Germany. Treatment of all plastic types in accordance with the government regulations proved to be particularly challenging.

At the same time, composite plastics were a completely new material introduced on the market. Special treatment methods are necessary to treat composite plastic materials because of their heterogeneity and varying compositions. Particularly useful for this purpose is raw material treatment. Since the mixed plastics waste collected by the Duales System includes a range of interfering substances, methods are being developed to significantly reduce the efforts needed for sorting, while ensuring that the plastic material has a specific degree of purity.

Examples of such processes are disclosed in WO 96/20819 and WO 99/36180, which describe the generation of mixed plastics waste agglomerates in dry treatment processes. Also, WO 98/18607 describes a sink-float separation process that removes polyolefin, among other processes.

WO 0077082 describes contacting a polyolefin plastic material with a solvent, adjusting the temperature of the solvent and possibly the ratio of solvent to the quantity of plastic in such a manner that many types of polymers are dissolved, so that mixed plastics waste is separated into a variety of pure polymers. In a final solid-liquid separation step, one polymer type is extracted using shearing. Particularly suitable for the separation of PP (polypropylene), LDPE (low density polyethylene), and HDPE (high density polyethylene) is a thermal separation process, such as that disclosed in DE 198 06 355 A1. The thermal separation process generates two liquid phases, in which one phase is rich in solvent and the other phase is rich in polymers.

Substances such as waxes, additives, decomposition products and other pollutants interfere with the subsequent treatment, particularly when the polyolefin is intended for use in new wares.

DE 41 22 277 A1 discloses a method in which shredded film made from polyethylene is subjected to a friction surface purification and extraction process involving vigorous agitation in a solution containing an organic solvent. This process allows the ingredients and polyethylene wax to be released from the shredder without actually dissolving the plastic itself while allowing the friction surface purification to remove printing ink. Solvents cited as suitable for this process include low-boiling point acetic ethers, such as methyl acetate, ethyl acetate, or isopropyl acetate; as well as low-boiling point alcohols, such as ethanol, with the acetic ethers being particularly preferred. The disadvantage of the process disclosed in DE 41 22 277 is the large quantity of solvent needed for the surface purification and extraction steps. The purification process disclosed in DE 4122 277 may be well suited for the special characteristics of film, because film has a high surface to volume ratio. However, composite or mixed plastics waste collected by the Duales System no longer contains a large amount of films.

The use of shearing to precipitate and retrieve polymers from solution is described in J. Polym. Sci.: Part B: Polym. Phys. 25: 953(1987). Short chain polymers remain in the solution and can be separated. In this manner, it is possible to separate certain products from the soluble contaminants. However, since the treatment of mixed plastics waste involves all the components in the waste, this method is commercially unfeasible because of the substantial technical effort necessary and/or the substantial costs associated with the transposition of the process into a technical commercially feasible process.

Therefore, it is an object of the present invention to provide a process that facilitates the treatment and purification of mixed plastics waste, including mixed plastics waste that does not contain films, preferably in a cost-effective and easy manner.

### SUMMARY OF THE INVENTION

In accordance with the process of the present invention, mixed plastics waste is brought into contact with an organic solvent. The organic solvent is characterized by being a solvent in which at least one of the macromolecular polymers present in the mixed plastics waste is soluble at a specific temperature. The term “specific temperature” means the temperature at which at least one polymer (preferably a macromolecular polymer) contained in the mixed plastics waste will dissolve in the organic solvent, used at that time, in more than from about 10 wt. % to about 15 wt. % in dissolved form. In a preferred embodiment of the process of the present invention, the solvent is maintained at atmospheric or normal pressure and at an operating temperature at which none of the macromolecular polymers are dissolved.

The ratio of waste to solvent is adjusted to produce a specific weight ratio of mixed plastics waste to solvent. During a specific residence time, the low molecular weight polymers are extracted. The term “specific residence time” means any of the following: the time required for a critical concentration of low molecular weight polymers to dissolve; the time required to dissolve the low molecular weight polymers to a desired concentration; or the time required to reach a concentration of low molecular weight polymers, after which time no significant increase in the concentration of low molecular weight polymers is likely to occur. The extracted mixed plastics waste (also referred to as purified mixed plastics waste) can be removed or separated from the solvent containing the extracted polymer, typically by using solid-liquid separation.

In accordance with another embodiment of the present invention, products with excellent material characteristics can be generated by first removing certain soluble components from the mixed plastics waste, including macromolecular polymers, before the waste is further dissolved to extract low molecular weight polymers. Certain soluble components can be removed from the mixed plastics waste at a temperature (T1) that is different from the operating temperature used to extract low molecular weight polymers. T1 can be a temperature that is lower or higher than the operating temperature. Preferably, T1 is lower than the operating temperature. In this way, certain soluble components are removed from the mixed plastics waste using solid-liquid separation methods before the waste is further dissolved to extract low molecular weight polymers and performing subsequent separation steps.

The instant method works particularly well if the mixed plastics waste is used in pellet form. In this connection, “pellets” means granulate or agglomerates that can be generated using methods known to those of skill in the art, including the above-identified dry and wet treatment processes. Granulates and in particular, agglomerates are very porous or have surface fissures so that, surprisingly, the extraction of low molecular weight polymers and other impurities can be performed with satisfactory purity results. Pellets also include the form of flowing liquid pellets.

In another preferred embodiment of the process in accordance with the present invention, the solvent need not be washed off. Such a preparatory step is not required in the instant invention because the organic solvent is chosen so that the macromolecular polymers in the mixed plastics waste are dissolved at polymer specific temperatures. By contrast, the processes disclosed in WO 00/77082 and DE 41 22 277 A1 do require the preparatory step of removing the solvent.

Basically, the order of the subsequent treatment separation steps can be adjusted as required for the particular purpose. The separation steps include, but are not limited to:

(1) dissolving and methods of solid-liquid separation steps, in order to remove insoluble components such as paper, aluminum and other polymers (depending on the solvent used);

(2) dissolving and phase separation, in other words, taking advantage of the presence of at least two liquid phases in order to separate materials with different polymer composition;

(3) dissolving and selective precipitation with or without shearing or liquid flow or by adding a precipitant;

(4) selective dissolving;

(5) dissolving and liquid-liquid extraction to remove low molecular weight parts using a second solvent; and

(6) dissolving and adsorption.

A variety of separation processes can be used in the present invention. For example, while dissolving a mixed plastics waste in an organic solvent, under specific conditions during the separation steps, a miscibility gap can occur so that two liquid phases are generated, such as that described in DE 198 06 355 A1. The generation of two liquid phases can be advantageous and each can be further treated separately. Also, selective precipitation can be produced from the liquid phases by the use of shearing or liquid flow or by adding a precipitant. This selective precipitation separation process can be performed alone or in combination with the liquid-liquid phase separation. Another separation process that can be used in the present invention is selective dissolving, which can be used alone or in combination with precipitation, using shearing or liquid flow or by adding a precipitant. The combination of selective dissolving can be used alone, with the liquid-liquid phase separation, or in combination with the above described precipitation processes.

In another embodiment of the present invention, the solvent can be removed after the extraction step. Thereafter, solvent can be added to the polymer material for subsequent separation, preferably using purified or fresh solvent, which is either chemically identical to the solvent removed or chemically non-identical to the solvent removed. Examples of solvents that can be used in the process of the present invention include, but are not limited to: aliphatic hydrocarbons, aromatic hydrocarbons, cyclical hydrocarbons, saturated hydrocarbons, unsaturated hydrocarbons, alcohols, carboxylic acids, amines, esters, ketones, tetrahydrofurane, bimethylformamide, dimethylsulfoxide, N-Methylpyrrolodone and mixtures thereof. In a preferred embodiment of the present invention, the solvent is either a hexane or an octane.

In another preferred embodiment of the present invention, the solvent is brought into circulation whereby, when a critical concentration of low molecular weight polymers is reached in the solvent, the solvent can be removed and purified using distillation. The purified solvent is then reused and returned for extraction in the process of the present invention.

The concentration of mixed plastics waste in the solvent could reach approximately 10 wt % to 20 wt. %, depending on the composition of the mixed plastics waste and on the type of solvent used.

In another preferred embodiment of the present invention, the operating temperature is maintained at from about 60° C. to about 70° C. In yet another preferred embodiment of the present invention, the residence time for removing approximately 80% of the wax lasts from about 60 minutes to about 90 minutes.

It is an embodiment of the present invention to provide a process for treating mixed plastics waste comprises macromolecular polymers and low molecular weight polymers, in which the process comprises the steps of: (a) introducing the mixed plastics waste into an organic solvent to produce a suspension, in which at least one of the macromolecular polymers in the mixed plastics waste is soluble in the solvent at a specific temperature at which the at least one macromolecular polymer dissolves; (b) maintaining the suspension at a normal pressure and at an operating temperature at which none of the macromolecular polymers dissolve; (c) extracting the low molecular weight polymers from the mixed plastics waste to produce a solution containing dissolved low molecular weight polymers and an extracted mixed plastics waste; and (d) removing the extracted mixed plastics waste.

In another embodiment of the present invention, the process for treating mixed plastics waste includes two additional steps prior to step (b) of: (i) dissolving at least one of the polymers contained in the mixed plastics waste at a temperature (T1) that is different from the operating temperature; and (ii) separating the at least one polymer dissolved in the solvent from the remaining polymers. T1 can be lower or higher than the operating temperature. In a preferred embodiment of the process of the present invention, T1 is lower than the operating temperature. In one embodiment of the process of the present invention, the separating step is conducted using a solid-liquid separation method.

In yet another embodiment of the process of the present invention, the ratio of the mixed plastics waste to solvent is adjusted obtain a specific weight ratio. In a preferred embodiment of the process of the present invention, the specific weight ratio of mixed plastics waste to solvent is from about 10 wt. % to about 20 wt. %.

In another embodiment of the process of the present invention, step (c) includes extracting for a specific residence time in solvent. In a preferred embodiment of the process of the present invention, the residence time is approximately 60 minutes to about 90 minutes. In yet another preferred embodiment of the present invention, the operating temperature is maintained at from about 60° C. to about 70° C.

In a preferred embodiment of the process of the present invention, the organic solvent is selected from the group consisting of aliphatic hydrocarbons, aromatic hydrocarbons, cyclical hydrocarbons, saturated hydrocarbons, unsaturated hydrocarbons, alcohols, carboxylic acids, amines, esters, ketones, tetrahydrofurane, bimethylformamide, dimethylsulfoxide, N-Methylpyrrolodone and mixtures thereof. In a most preferred embodiment of the process of the present invention, the organic solvent is selected from the group consisting of octanes and hexanes.

In another embodiment of the present invention, the process for treating mixed plastics waste includes the steps of: (i) removing the solution when a critical concentration of low molecular weight polymers is reached in the solution, and (ii) purifying the solvent from the solution using distillation to produce purified solvent and the purified solvent is reused for the extracting. Other embodiments of the process of the present invention include a solvent replacement step subsequent to extraction step (c), in which the solvent replacement step includes: (i) removing the solvent; and (ii) adding solvent to the polymer material for the subsequent separation, in which the solvent is either chemically identical or non-identical to the solvent removed.

In another embodiment of the present invention, the mixed plastics waste includes interfering soluble pollutants. In another embodiment of the present invention, the mixed plastics waste includes interfering soluble pollutants and the separating involves separating the at least one polymer dissolved in the solvent from both the remaining polymers and at least one part of the interfering soluble pollutants. In a preferred embodiment of the present invention, the mixed plastics waste is in the form of pellets, the pellets selected from the group consisting of granulate pellets, agglomerate pellets and flowing liquid pellets.

In another embodiment of the present invention, the process includes at least one additional separation step in which the extracted mixed plastics waste generates polymer material. In yet another embodiment of the present invention, the process includes at least one additional separation step in which the extracted mixed plastics waste generates a polymer material. Other embodiments of the process of the present invention include at least one additional separation step subsequent to step c), in which the at least one separation step is selected from the group consisting of: (i) dissolving the extracted mixed plastics waste to produce solid and liquid parts, and separating the solid and liquid parts using solid-liquid separation to remove insoluble components; (ii) dissolving the extracted mixed plastics waste to produce at least two liquid phases and separating the phases to separate materials with different polymer composition;(iii) dissolving the extracted mixed plastics waste and selectively precipitating at least one precipitant; (iv) selectively dissolving the extracted mixed plastics waste; (v) dissolving the extracted mixed plastics waste and performing liquid-liquid extraction to remove low molecular weight polymers, using and a second solvent; (vi) dissolving the extracted mixed plastics waste and performing adsorption; (vii) dissolving the extracted mixed plastics waste and selectively precipitating at least one precipitant, and shearing or liquid flow or the addition of a precipitant; and any combination of (i)-(vii).

### BRIEF DESCRIPTION OF THE DRAWINGS

FIG. 1 is a schematic representation of the process in accordance with the invention and an extraction apparatus in which the process can be conducted.

FIG. 2 is a drawing showing the wax concentration in the solvent over time.

The invention is described in further detail below with reference to the drawings and examples.

### DETAILED DESCRIPTION OF THE INVENTION

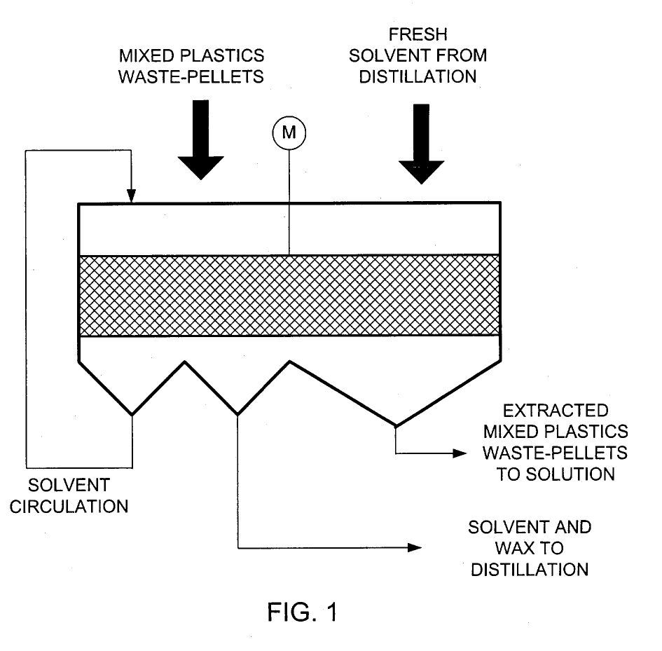

FIG. 1 schematically illustrates a process of the present invention and an extraction apparatus in which the process can be conducted. Such an apparatus can include a Motor (M) driven carousel extractor. The mixed plastics waste pellets are brought into contact with the solvent in a specific weight ratio. For example, the mixed plastics waste pellets, comprising polypropylene and polyethylene, are brought into contact with hexane, in a specific weight ratio. Agitation is used to create a modest movement of pellets relative to solvent. The solvent temperature is adjusted to between 60° C. and 70° C., preferably to 65° C. After a 70 to 90 minutes residence time, the extracted mixed plastics waste pellets are separated from the solvent. The extracted mixed plastics pellets are subsequently dissolved by treatment in a solvent kettle containing hexane. There is no need to purify the extracted mixed plastics pellets with hot water and drying, as is required in other methods. The polymer material generated after subsequent separation can be newly manufactured with the addition of additives.

Once that a critical concentration of low molecular weight polymers is reached in the solvent, the polluted solvent is at least partially removed and purified using distillation. Fresh solvent, preferably purified solvent taken from the distillation, is then added to the extracted mixed plastics waste.

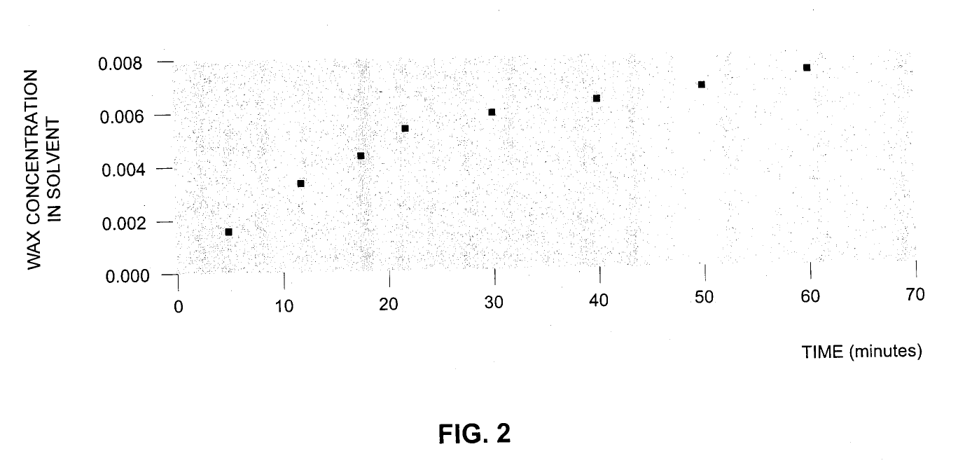

FIG. 2 illustrates the increasing wax concentration in the solvent over time. It is possible that no significant increase in wax concentration occurs after approximately 40 minutes. When no significant increase in wax concentration occurs, the polluted solvent is removed, or solvent is added that is either fresh solvent or purified solvent from distillation.

The examples were conducted on a laboratory scale. When converting to and/or scaling up from the laboratory methods to commercial use, adjustments are made for different concentrations of solvents to mixed plastics waste. Also, different solvents may be used.

### EXAMPLE 1

Glass cylinders are filled with both 100 g of mixed plastics waste, such as that collected by the Duales System, and 500 g n-octane. The mixed plastics waste and solvent are mixed using a circulation pump. The mixed plastics waste is extracted for 135 minutes at 65° C. The damp mixed plastics waste is then dissolved in purified or fresh n-octane to generate a concentration of 13.8 wt. %. Finally, the solution is filtered. While mixing the filtered solution vigorously, it is cooled to 65° C. During this process, a portion of the plastics content is precipitated while another portion remains dissolved in the solvent. The suspension generated in this manner is separated using filtration and the filtrate is evaporated. An LDPE-rich plastic is generated that is largely free of soluble pollutants and has mechanical characteristics similar to new ware.

### EXAMPLE FOR COMPARISON

100 g mixed plastics waste, such as that collected by the Duales System, is dissolved in 860 g n-octane. The solution is then filtered. While mixing the filtered solution vigorously, it is cooled to a temperature of 65° C. During this process, a portion of the plastic components contained in solution precipitate, while another portion of the plastic components remains dissolved in the solution. The suspension generated in this manner is separated using filtration and the filtrate is evaporated. An LDPE-rich plastic material is generated that contains a higher percentage of soluble pollutants.

The process of the present invention, disclosed herein and in the claims, can be performed both individually and in any chosen combination to implement the invention.

The foregoing disclosure of the embodiments and preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The present invention is not limited to the examples, claims or their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps as described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written to the extent that the method or process does not rely on the particular order of steps and one skilled in the art can readily appreciate that the sequences may be varied and still remain within the description, spirit, and scope of the present invention.

12. (New) A process for treating mixed plastics waste comprising macromolecular polymers and low molecular weight polymers, wherein said process comprises the steps of:
(a) introducing the mixed plastics waste into an organic solvent to produce a suspension, wherein at least one of the macromolecular polymers in said mixed plastics waste is soluble in said solvent at a specific temperature at which said at least one macromolecular polymer dissolvent;
(b) maintaining the suspension at a normal pressure and at an operating temperature at which none of the macromolecular polymers dissolve;
(c) extracting said low molecular weight polymers from the mixed plastic waste to produce a solution containing dissolved low molecular weight polymers and an extracted mixed plastics waste; and
(d) removing the extracted mixed plastics waste.

13. (New) The process of claim 12, said process further comprising two additional steps prior to step (b) of:
(i) dissolving at least one of the polymers contained in said mixed plastics waste at a temperature (T1) that is different from the operating temperature; and
(ii) separating said at least one polymer dissolved in the solvent from the remaining polymers.

14. (New) The process of claim 13, wherein T1 is lower than the operating temperature.

15. (New) The process of claim 13, wherein T1 is higher than the operating temperature.

16. (New) The process of claim 13, wherein said separating uses a solid-liquid separation method.

17. (New) The process of claim 12, wherein step (b) further comprising adjusting for a specific weight ratio of mixed plastics waste to solvent.

18. (New) The process of claim 17, wherein said specific weight ratio of mixed plastics waste to solvent is from about 10 wt.% to about 20 wt.%.

19. (New) The process of claim 12, wherein step (c) further comprises extracting for a specific residence time in solvent.

20. (New) The process of claim 19, wherein said residence time is from about 60 minutes to about 90 minutes.

21. (New) The process of claim 12, wherein said operating temperature is maintained at from about 60° C. to about 70° C.

22. (New) The process of claim 12, wherein said organic solvent selected from the group consisting of aliphatic hydrocarbons, aromatic hydrocarbons, syslical hydrocarbons, saturated hydrocarbons, unsaturated hydrocarbons, alcohols, carboxylic acids, amines, esters, ketones, tetrahydrofurane, bimethylformamide, dimethylsulfoxide, N-Methylpyrrolodone and mixtures thereof.

23. (New) The process of claim 22, wherein said organic solvent is selected from the group consisting of octanes and hexanes.

24. (New) The process of claim 12, further comprising the additional steps of:
(i) removing said solution when a critical concentration of low molecular weight polymers is reached in the solution, and
(ii) purifying the solvent from said solution using distillation to produce purified solvent and said purified solvent reuced for said extracting.

25. (New) The process of claim 12, wherein said mixed plastics waste further comprises interfering soluble pollutants.

26. (New) The process of claim 13, wherein said mixed plastics waste further comprises interfering soluble pollutants and said separating further comprises separating said at least one polymer dissolved in the solvent from both the remaining polymers and at least one part of said interfering soluble pollutants.

27. (New) The process of claim 12, wherein the mixed plastics waste is in the form of pellets, said pellets selected from the group consisting of granulate pellets, agglomerate pellets and flowing liquid pellets.

28. (New) The process of claim 12, further comprising an additional separation step wherein said extracted mixed plastics waste generates polymer material.

29. (New) The process of claim 12, further comprising at least one additional separation step subsequent to step c), wherein said at least one separation step selected from the group consisting of:
i) dissolving said extracted mixed plastics waste to produce solid and liquid parts, and separating said solid and liquid parts using solid-liquid separation to remove insoluble components;
ii) dissolving said extracted mixed plastics waste to produce at least two liquid plasics and separating the phases to separated materials with different polymer composition;
iii) dissolving said extracted mixed plastics waste and selectively precipitating at least one precipitant;
iv) selectively dissolving said extracted mixed plastics waste;
v) dissolving said extracted mixed plastics waste and performing liquid-liquid extraction to remove low molecular weight polymers, using and a second solvent;
vi) dissolving said extracted mixed plastics waste and performing adsorption;
vii) dissolving said extracted mixed plastics waste and selectively precipitating at least one precipitant, further comprising shearing or liquid flow or the addition of a precipitant; and
viii) any combination of(i)-(vii).

30. (New) The process of claim 29, further comprising at least one additional separation step wherein said extracted mixed plastics waste generates a polymer material.

31. (New) The process of claim 12, further comprising a solvent replacement step subsequent to extraction step (c), wherein said solvent replacement step comprises:
(i) removing the solvent; and
(ii) adding solvent to the polymer matirial for the subsequent separation, wherein said solvent is either chemically identical or non-identical to the solvent removed.
